(19) United States
(12) Patent Application Publication
(10) Pub. No.: US 2009/0078905 A1
(43) Pub. Date: Mar. 26, 2009

(54) Versatile valve

(76) Inventors: Joseph Peter Marcilese, Chatsworth, CA (US); Dean C. Richards, Chatsworth, CA (US); Michael C. Gagne, Chatsworth, CA (US)

Correspondence Address: Maria Erlinda C. Sarno, Esq., P.O. Box 1023, Artesia, CA, 90702, US

(21) Appl. No.: 12/313,551

(22) Filed: Nov. 21, 2008

Related U.S. Application Data
(63) Continuation-in-part of application No. 11/113,475, filed on Apr. 25, 2005.

(51) Int. Cl. F16K 27/00

(52) U.S. Cl. 251/366

(57) ABSTRACT

A valve comprising a bonnet, an actuator for controlling the movement of a diaphragm situated between the bonnet and a valve body having an inlet port, an outlet port, a passageway connecting the inlet port and the outlet port for fluid flow, the valve body having an access receiving port for accommodating a device. The access receiving port is designed to accommodate any type of instrumentation testing a parameter of a process fluid or product on a process system. The proposed valve body can replace an existing valve body thereby avoiding the need to replace the entire valve. The access receiving port can have the same design or different designs. It is located either above or into the passageway of the valve body for a weir type valve or into the passageway of the valve body for a radial style valve.

This is a continuation-in-part application of Ser. No. 11/113,475 filed Apr. 25, 2005 which is hereby incorporated by reference.

This invention relates to the use of the valve body of a valve as an access receiving port for instrumentation used in testing different parameters of a process fluid or product along a process stream.

### BACKGROUND

There is an ongoing desire in the industry, especially those that process costly products or products found only in limited quantity, to maximize product recovery and minimize product loss. Losses may come from physical or chemical causes. The claimed invention deals with physical loss of product along the process system, most likely due to product retention at the piping, interconnections or equipment used for processing. One of the major causes of product retention is due to the installation of instrumentation and devices along the process system. Test instruments, measuring or sensing devices are collectively referred to herein as instrumentation, whether it is singular or plural. This instrumentation monitor process conditions by testing in-process fluid. Each instrumentation is usually installed by a connector. Every instrumentation installed in the conventional manner along the process stream usually adds a dead leg. Dead legs are areas where fluid may become trapped or held up within the process system such as product retention on the pipes due to inadequate drainage, pockets usually caused by sharp turns in the interconnection of parts, and poor design of the devices and equipment used in the process. Dead legs created by the installation of the instrumentation usually are on the coupling of sample tees and on the additional pipes and valves connecting the instrumentation to the process stream. This invention focus on minimizing product loss due to the attachments of instrumentation. The instrumentation here are limited to those used for obtaining parameters and test results on the characteristics and properties of the process fluid or the product itself, hereinafter also simply referred to as parameter/s, and not to instrumentation that are intrinsic or integral to a device for monitoring the proper functioning of the device used in the process. Instrumentation that are intrinsic or integral to the device, simply referred to herein as integral instrumentation, placed at specific location relative to the device may add to the dead leg but any dead leg due to these integral instrumentation may be unavoidable or can be minimized by installing these with the other instrumentation. The proposed invention does not cover for example, pressure gauges (integral instrumentation) installed on pressure valves (devices) or flow meters (integral instrumentation) installed on pumps (devices or equipment) since these are integral to the device to measure the performance or ensure that the device is functioning as expected. To be within the claimed invention, there should be an instrumentation for obtaining parameters and test results on the characteristics and properties of the process fluid, alone or in addition to the integral instrumentation. Walker (U.S. Pat. No. 5,944,850) is an example of the type of instrumentation that is beyond the scope of the invention where a pressure gauge (integral instrumentation) is placed on the valve body of a back pressure valve (device) to monitor the performance of the valve. Putting more than one device or instrumentation to monitor the function of the device and not the characteristics or properties of the product or process fluid through the system is likewise out of the scope of this invention such as the two pressure valves in communication with each other to meter the fluid pressures across the valve seat as described by Wang (US2004/0261862). More than one type of instrumentation in the absence of any integral instrumentation is also within the scope of this invention. There are a number of improvements made on minimizing dead legs in the use of devices, herein the weir and radial style valves as example. Most of these deal with providing multiple output ports from a single inlet port to minimize product loss or hold up experienced with the use of multiple valves. With a single valve having multiple ports, one minimizes the potential product loss at the connectors, especially the tee connectors, required to join several valves and at the internal chambers of each additional valve used within the system. Examples of these types of valves are described in U.S. Pat. No. 5,906,223 which proposes an entire valve assembly machined out of a single block of material having smooth liquid pathways and shared fully flushable flow compartments and U.S. Pat. No. 5,273,075 proposing a diaphragm valve having a single inlet port and two outlet ports in which the flow of fluids can be directed from the inlet port to one or the other outlet ports. Most instrumentation are placed either before the valve or after the valve because of the increased number of locations where an instrumentation can be placed. Further, testing proximal to the valve is preferred because of the ability of these valves to stop, reduce, increase or maintain the flow of fluid according to the conditions required by the test method or by the instrumentation. These instrumentation are usually connected by clamping or joining together, the connector for the instrumentation and the connector at the inlet or outlet port of the valve. The connector on the instrumentation is herein referred to as access port to differentiate this from the connector port at the inlet and outlet of a valve. The connector on the valve body which will be described later is referred to as access receiving port to differentiate this from the access port on the instrumentation. While dead leg has been minimized by reducing the number of valves, it should not be ignored that potential product hold up also occurs at every joint or connection between the instrumentation and the device, a valve in this case. It is common to most biological and pharmaceutical processing, for example, to have a number of parameters tested on the in-process product or fluid along the process such as pH, concentration, temperature, viscosity, turbidity, dissolved oxygen and the like. Instrumentation for detecting, sensing or testing these parameters are not integral or intrinsic to a device. When one considers the number of parameters that are tested during production and the number of times they are monitored, the potential product hold up becomes sizeable. Fazekas (U.S. Pat. No. 6,675,828) tried to address this problem by introducing an instrument station, a pipe having several instrumentation and connecting this or a number of these along the process stream. While this is an improvement at the right direction, product retention still occurs on the extra pipe carrying these test instruments which require certain dimensions such as length and diameter to cater to their respective operation. To really minimize loss, it is proposed to introduce these instrumentation into the valve body of a valve as opposed to connecting these at the inlet or outlet ports of the valve. Testing or installation of instrumentation into the valve body does not add anymore surfaces that could retain process fluids or products since the valve body is already within the valve used in the process stream.

It is therefore an object of this invention to reduce product loss caused by physical retention of products at the pipes and joints between the valve and the instrumentation.

It is also an object of this invention to provide a valve that includes an access receiving port for the instrumentation within the valve body thereby minimizing the number of pipes, joints and valves in the process system.

It is a further object of this invention to provide a valve having a valve body with multiple variety of ports catered to connect with the different types instrumentation.

It is also a further object of this invention to provide a more accurate measurement of process fluid and product parameters by allowing the instrumentation to take measurements on the fluid within the valve body of a valve.

It is still a further object of this invention to allow removal and reinstallation of an instrumentation on an access receiving port of a valve.

It is still also a further object of this invention to cut the cost and space requirement for the process system by reducing the number of connectors, valves and pipes used by the process.

### SUMMARY OF THE INVENTION

This invention relates to a valve comprising a bonnet, an actuator for controlling the movement of a diaphragm situated between the bonnet and a valve body having an inlet port, an outlet port, a passageway connecting the inlet port and the outlet port for fluid flow, the valve body having an access receiving port communicating with the passageway of the valve body for accommodating an instrumentation. The access receiving port can be designed to accommodate any type of instrumentation especially an instrumentation which is usually a testing, measuring or a sensing instrument. The access receiving port connects with a matching access port of the instrumentation. The instrumentation here tests a parameter of a process fluid or product on a process system and do not cover instrumentation that monitor proper functioning of a device placed or installed along the process system. The access receiving port may be one or more than one. The maximum number of access receiving ports that can be placed on the valve body of a valve depend upon the structural strength and performance expected from the valve. This can be easily determined on a case by case basis. To minimize the cost of adopting the proposed valves, the valve body with the access receiving port/s can replace a valve body without an access receiving port, thereby doing away with the need to replace the entire valve. For greater flexibility, it is desirable to design new instrumentation with the same access port that would fit into the same or matching access receiving port on the valve body. An access port is connected to an instrumentation while an access receiving port is connected or is a matching opening on the valve body of the valve. The valve body, however, can have the same or different types of access receiving ports to cater to the different size, shape, design, and method of attachment of a particular instrumentation. The access receiving port is located either above or into the passageway of the valve body for a weir type valve or into the passageway of the valve body for a radial style valve. It is recommended to construct the access receiving port to drain into the passageway of the valve body or to position the valve body so that fluid at the access receiving port drains into the passageway. An access receiving port that allows contact of an instrumentation directly with the fluid inside the valve body, either at an inlet side or at an outlet side of the passageway of the valve body can enable the instrumentation to get more accurate test results. The access receiving port herein allow removal and replacement of the instrumentation. The passageway of the valve body of a weir type valve can be lengthened or the valve body of a radial style valve can be enlarged to accommodate more instrumentation, if needed. The access receiving port can be made of metal or non-metal or a combination of both.

Other embodiments of the present invention will become readily apparent to those skilled in the art from the following detailed description, wherein it shows and describes only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWING

Aspects of the present invention are illustrated by way of example, and not by way of limitation, in the accompanying drawings, wherein:

FIG. 1 is an exploded isometric view of a weir type valve.

FIG. 1A is an isometric view of an assembled weir type valve.

FIG. 2 is an exploded isometric view of a radial style valve.

FIG. 2A is an isometric view of an assembled radial style valve.

FIG. 3 shows the current method of attaching a small instrumentation proximal to a valve within a process system.

FIG. 4 shows the current method of attaching a large instrumentation proximal to a valve within a process system.

FIG. 5 shows the current method of attaching instrumentation in a multiple outlet port valve.

FIG. 6 is an isometric view of the proposed weir type valve having an access receiving port at the valve body of the device.

FIG. 6A is an isometric view of FIG. 6 with an instrumentation attached.

FIG. 7 is an isometric view of a valve body of a weir type valve having multiple types of access receiving ports for accommodating multiple instrumentation.

FIG. 7A is an isometric view of a valve body of a radial style valve having multiple access receiving ports for accommodating multiple instrumentation.

FIG. 8 is a cross sectional view of a valve body of a weir type valve having different types of access receiving ports for different types of instrumentation.

FIG. 8A is a cross sectional view of a valve body of a radial style valve having different access receiving ports for different types of instrumentation.

### DETAILED DESCRIPTION OF THE INVENTION

The detailed description represented herein is not intended to represent the only way or the only embodiment in which the claimed invention may be practiced. The description herein is provided merely as an example or examples or illustrations of the claimed invention and should not be construed as the only way or as preferred or advantageous over other embodiments or means of practicing the invention. Any means of incorporating an instrumentation directly into a valve body of a weir type or radial style valve to test, sense or measure a parameter on the fluid process or product to reduce dead leg, thereby reducing product loss due to physical hold up or retention of product associated with the installation of devices along a process system is within the scope of this invention. The detailed description includes specific details to provide a thorough understanding of the claimed invention and it is apparent to those skilled in the art that the claimed invention may be practiced without these specific details.

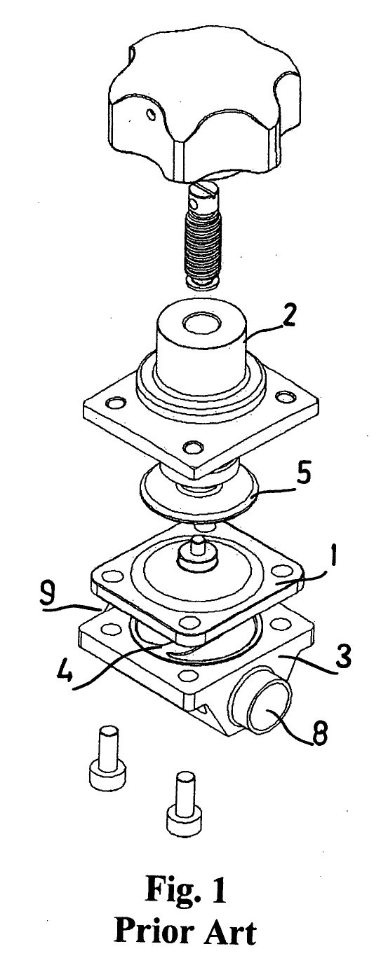

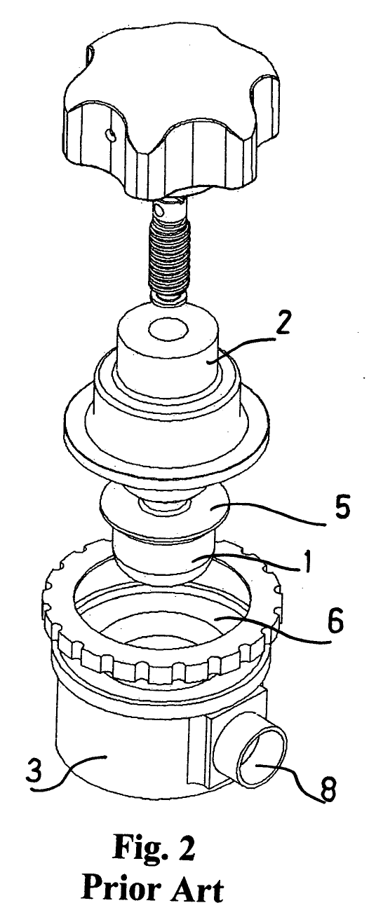

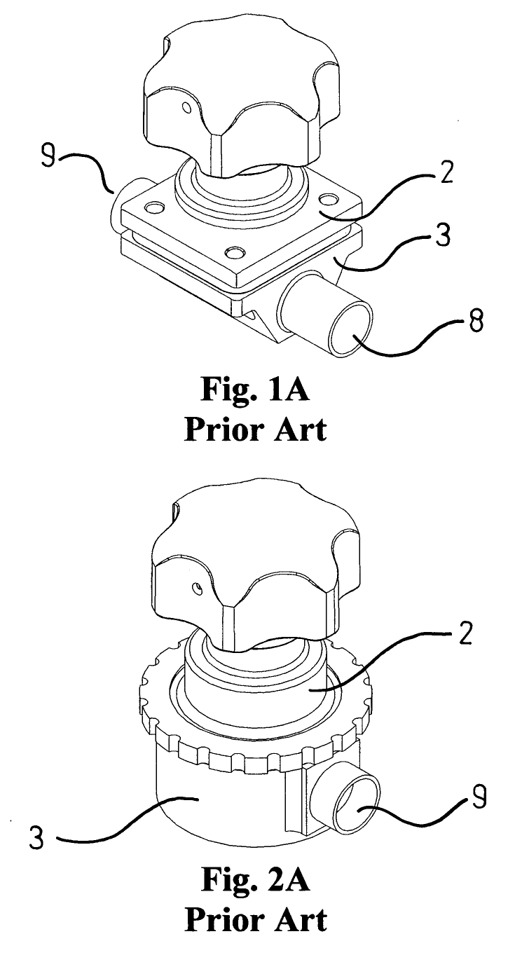

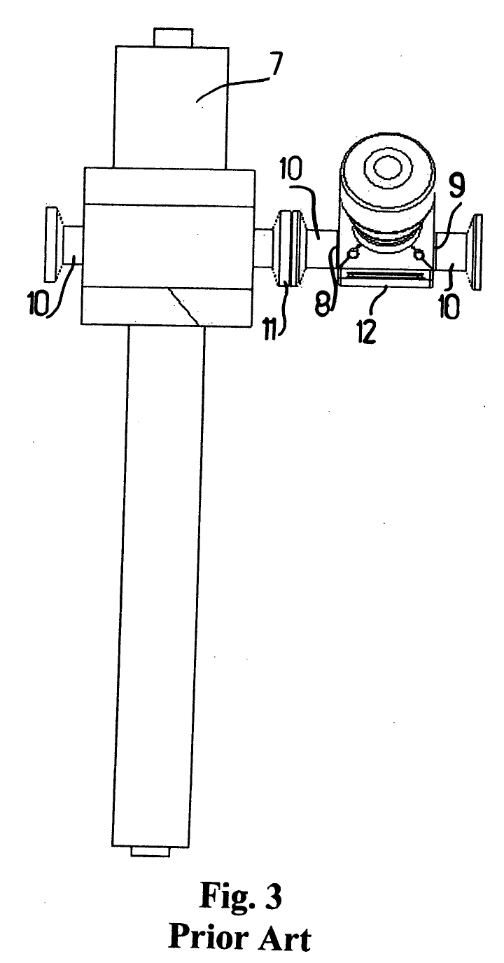

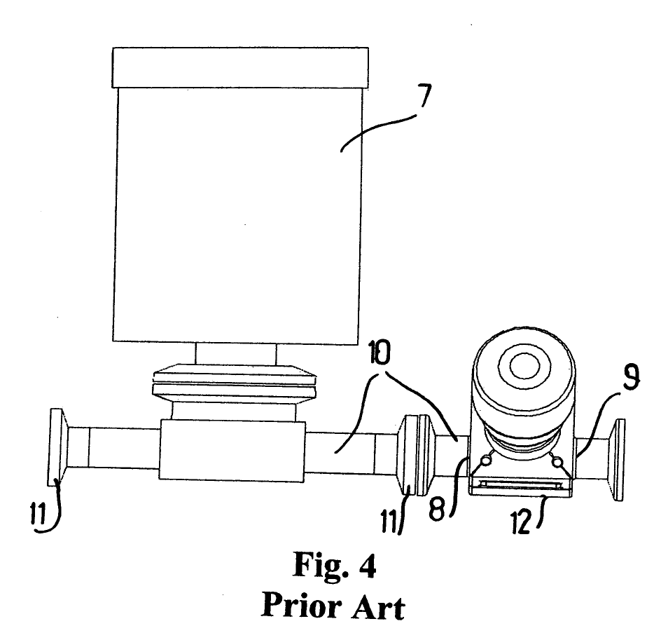

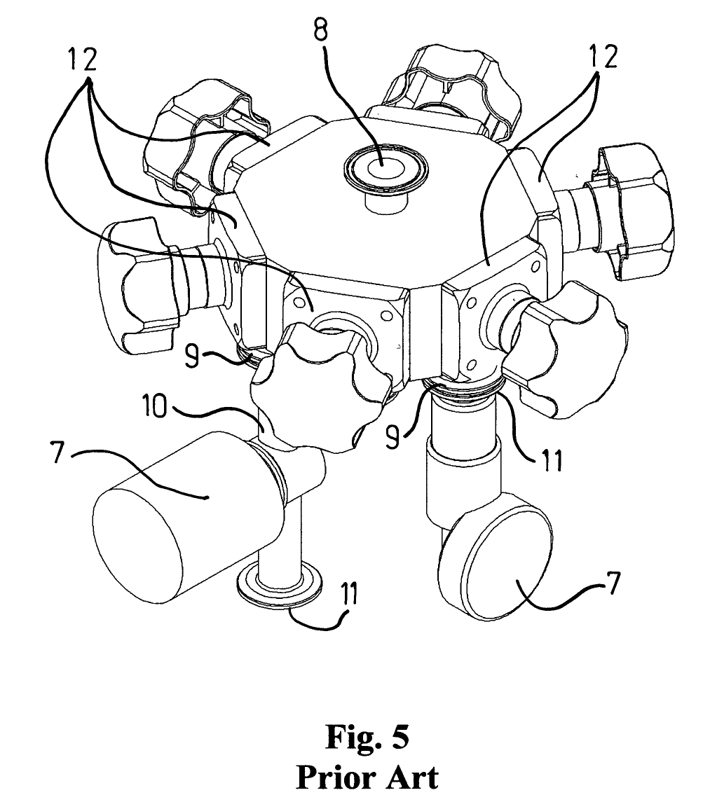

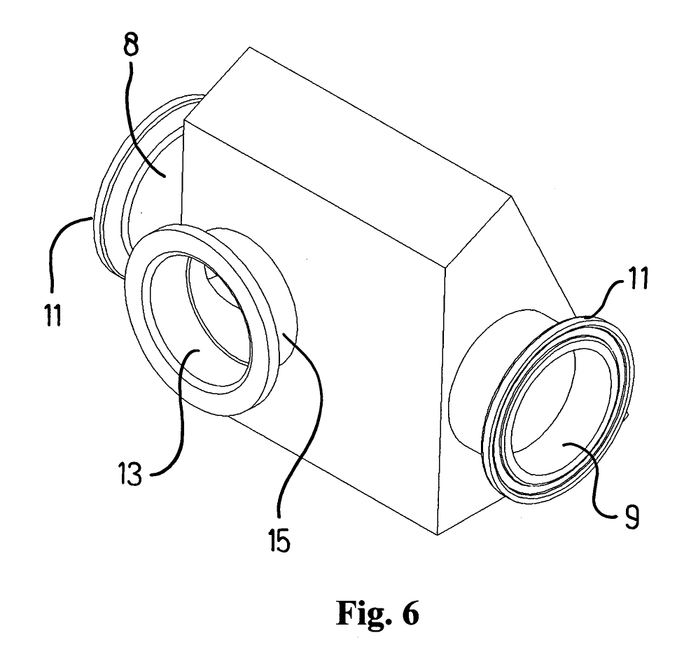

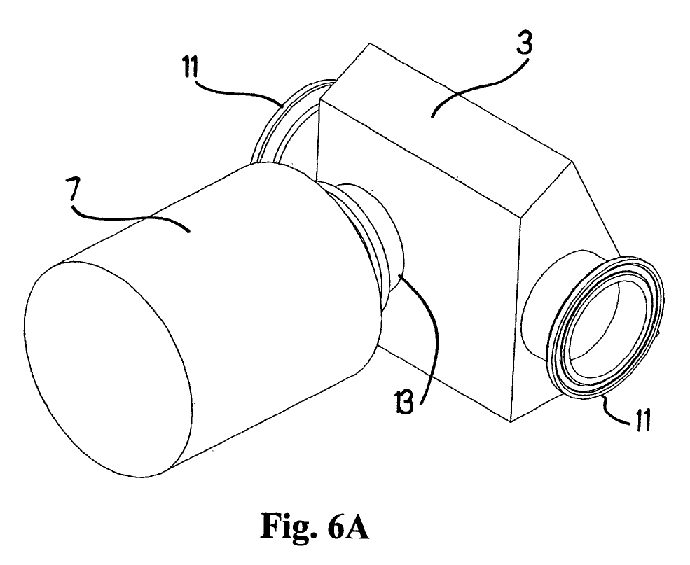

FIGS. 1 and 2 show the components of a weir type and radial style valve, respectively, while FIGS. 1A and 2A shows their corresponding assembled valves. Similar parts of the valves are given the same number. Both valves have a diaphragm 1 and their bonnets 2 are similar in structure. In the weir type valve as the name denotes, the valve has a weir 4 between the inlet 8 and the outlet 9 port of the valve body 3. Fluid flow is controlled by the diaphragm 1 completely pressing on the weir 4 to stop the flow or releasing from the weir to allow the flow. Intermediate flow rates are attained by the diaphragm slightly pressing on the weir. The movement of the diaphragm to or away from the weir is controlled by an actuator 5. In the radial style valve, the diaphragm 1 presses on a valve seat 6 to close the flow or disengages from the valve seat to allow the flow of fluid. Currently, a device such as a test instrument 7 is usually connected before a valve inlet 8 or after a valve outlet 9 as shown in FIG. 3. FIG. 5 shows how a multiple (only two are illustrated herein) of these instrumentation 7 can connect to each outlet port 9 of a valve 12. As shown, this results in additional piping 10 between the valve and the instrumentation where product can potentially be retained even in a drainable process system because a certain amount of product tend to adhere on the inside surface of the pipes 10 and the connectors 11. Dead legs still exist, although minimized, by a valve having multiple outlet ports because each outlet port can directly connect to an instrumentation as shown in FIG. 5 where there is only one inlet port instead of having multiple independent valves as shown in FIGS. 3 and 4 where there is one inlet port for each outlet port. Further, the amount of dead leg also depend upon the size of the instrumentation. FIG. 3 shows a smaller instrumentation such as a pH meter connected to a valve while FIG. 4 shows a larger instrumentation like a temperature transmitter connected to a valve 12. More dead leg thereby more product loss is expected from larger instrumentation.

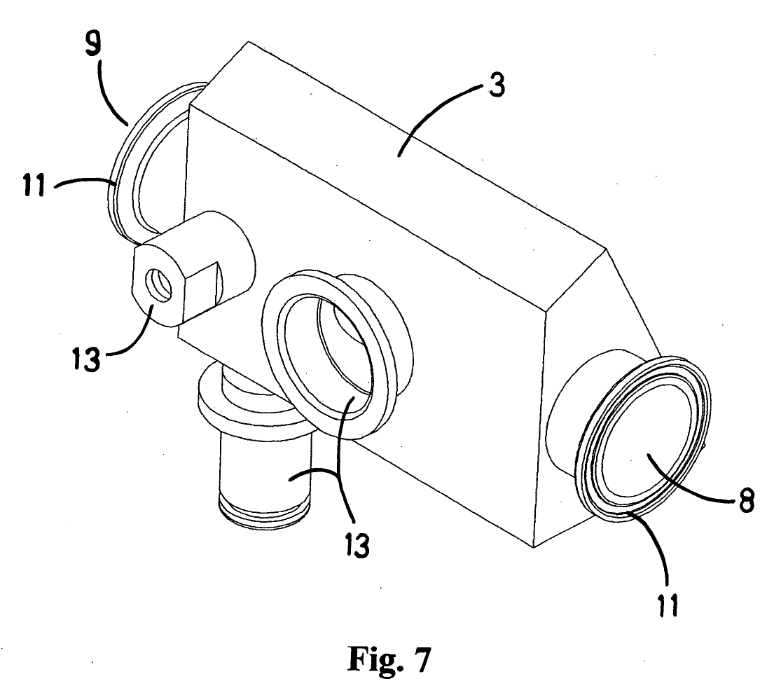

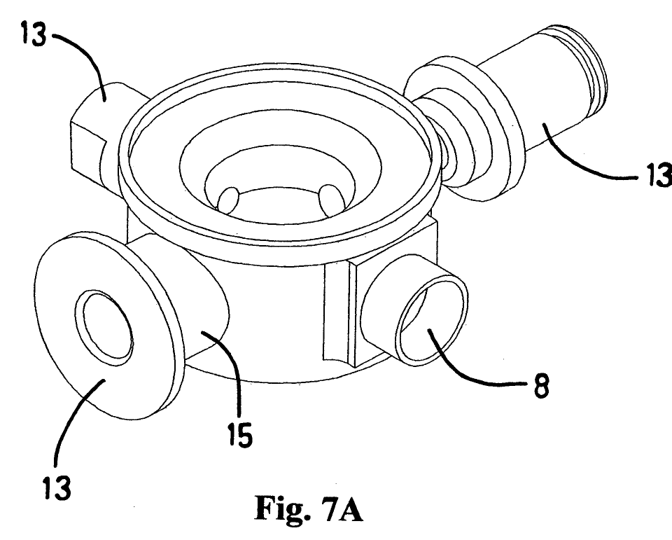

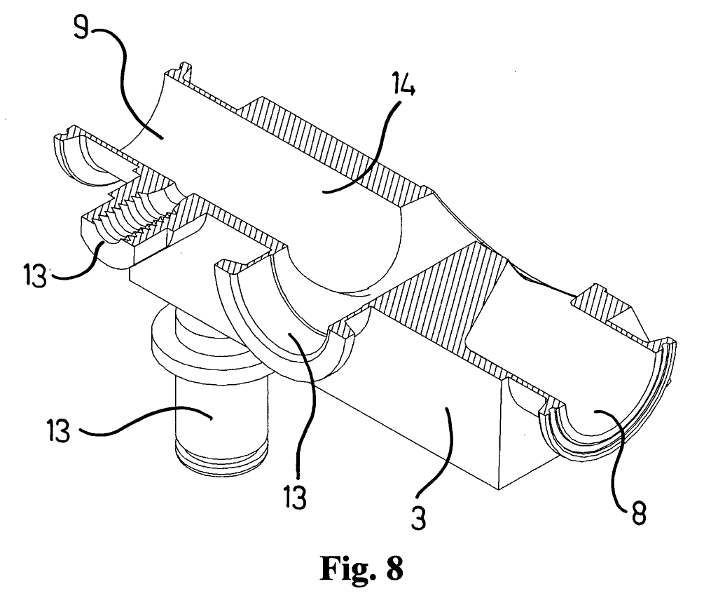

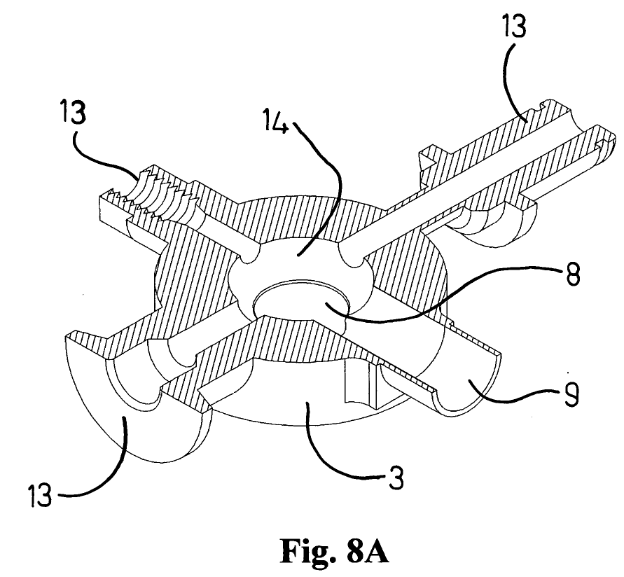

To minimize these dead legs, it is proposed to install instrumentation directly to the valve body 3 as shown in FIGS. 6, 7 and 8. FIG. 6 shows the valve body of a weir type valve having an access receiving port 13 without an attached device while FIG. 6A shows the valve body having an instrumentation 7 connected to the valve body through an access receiving port 13. All devices and their examples are identified with the number 7. With this type of connection, dead legs due to the extra pipe 10, connector 11 and valve 12 needed to connect an instrumentation at the inlet 8 or the outlet port 9 of the valve are minimized. With the elimination of these extra piping, connectors and valves, one also realizes tremendous savings in the overall cost of the process system by reducing the number of valves, connectors and piping to connect one component with another as well as in the reduction of space requirement to house the process system which are also vital to a manufacturer. Effort to minimize dead leg by introducing or installing instrumentation directly into the valve body has not been done in the past As mentioned above, these instrumentation were installed near the valves, either on the inlet or outlet port of the valves It was unexpected to see that the valve body, in fact, provided a good location to place these instrumentation because certain types of instrumentation are more suited for a certain type of flow. For example, the flow at the inlet side, before the weir, is laminar which is a good site to place instrumentation measuring conductivity, dissolved oxygen, reduction-oxidation potential, UV, Visible and IR absorption. Other instrumentation without requiring a laminar flow, are usually installed after the weir where the flow is turbulent and also to give room for the instrumentation requiring laminar flow. pH, temperature, temperature transmission are examples of these instrumentation. As shown in FIG. 6A, a test instrument 7 connects to an access receiving port 13 located at the valve body 3 and not at the connector port 11 of an inlet or outlet port of the valve body. Several of these access receiving ports 13 can be installed directly to the valve body without the need to alter the size of the diaphragm, weir or valve seat as shown in FIGS. 7 and 7A. Therefore, one can use the existing valves replacing only the existing valve body with the new proposed valve body having the access receiving port/s. At times, however, it may be necessary to lengthen the passageway 14 inside the valve body 3 to and from the weir 4 or enlarge the valve body 3 of the radial style valve as shown in FIGS. 7, 7A, 8 and 8A to accommodate more instrumentation. The size, shape, number and method of attachment of the access receiving ports shown in FIGS. 7, 7A, 8 and 8A are merely illustrative and not comprehensive. The access receiving ports 13 can be designed to cater to a particular device 7. The number of access receiving ports will depend upon the structural strength and the performance expected from the valve as well as the size of the space along the passageway 14 of the valve body 3 for a weir type valve or into the passageway 14 of a radial style valve. Also, the length of the pipe 15 attached to the access port 13 can be minimized according to the requirements of the instrumentation. The valve and its components as well as the access receiving ports herein can be made or manufactured with metal or non-metal or a combination of both according to the discretion of the manufacturer or the user.

For test instrumentation that needs direct contact with the process fluid or product, the access receiving port should allow the instrumentation to reach into the fluid inside the valve body. This was an untried field since it is not known if introduction at this site would provide a reliable result or if the instrumentation will not be damaged when introduced at this site. Attachment of the test instrumentation directly on the fluid present inside the valve body of a weir type valve and a radial style valve rather than at a distance before the inlet or after the outlet port of the valve provided an unexpected opportunity to test the same fluid flowing at a laminar flow and at a turbulent flow. For these type of valves, flow is laminar at the inlet of the passageway of the valve body and turbulent at the outlet of the passageway of the valve body. Testing at these points also provided an unexpected opportunity to get a more timely result on the process fluid and product parameters which allowed the operator to stop the process immediately and correct the conditions before the whole batch of product is wasted or reworked. In a given process, there are usually several parameters on the process fluid or product that are tested such as pH, temperature, conductivity, turbidity, temperature transmission, dissolved oxygen, oxidation reduction potential, UV, visible and infrared absorption, etc. Whether these tests are best conducted under a laminar or turbulent flow is known to the technical operators. Instrumentation with the same access port design would be able to exchange positions with each other within the valve body so long as these instrumentation require the same type of flow characteristics or do not require a particular type of flow. For example one valve body would connect a pH probe in one process and connects a thermometer for another process since both of these tests are not flow sensitive and also if these two test instrumentation share the same type of access receiving port, that is, same size, shape and method of attachment. For clarity, the connecting port attached to the instrumentation is referred to as access port while the corresponding matching port in the valve body is referred to as access receiving port. For instrumentation especially test instruments having their own unique access port, the access receiving ports of the valve body would cater to their individual design. Being an access receiving port, it is also possible to close or cap any port that may not be needed for a particular process. The access port and more important, the access receiving ports on the valve body are recommended to be designed or the valve body oriented at a given position to make sure that the process fluid or product are drainable into the passageway of the valve body to prevent for example, puddling of the process fluid or product on the instrumentation, otherwise, these will lose whatever advantage they provided by being installed or placed on the valve body.

While the embodiments of the present invention have been described, it should be understood that various changes, adaptations, and modifications may be made therein without departing from the spirit of the invention and the scope of the claims.

We claim:

1. A weir type or a radial style valve comprising:
a bonnet, an actuator for controlling the movement of a diaphragm situated between the bonnet and a valve body having an inlet port, an outlet port, a passageway connecting the inlet port and the outlet port for fluid flow, the valve body having an access receiving port communicating with the passageway of the valve body, the access receiving port connecting to a matching access port of an instrumentation, each instrumentation testing a parameter of a process fluid or product on a process system other than monitoring proper functioning of a device installed along the process system, the instrumentation replaceable and removable from the access receiving port.

2. The valve of claim 1 wherein the instrumentation is a test instrument, a measuring or a sensing device.

3. The valve of claim 1 wherein the access receiving port connecting to the matching port of the instrumentation are constructed to drain into the passageway of the valve body.

4. The valve of claim 1 wherein the access receiving port in the valve body is more than one.

5. The valve of claim 4 wherein the maximum number of access receiving port in the valve body depend upon a structural strength and performance expected from the valve.

6. The valve of claim 1 wherein the valve body with the access receiving port can replace a valve body of an existing valve without an access receiving port.

7. The valve of claim 1 wherein the access receiving ports at the valve body are of the same type.

8. The valve of claim 1 wherein the access receiving ports at the valve body are of different types.

9. The valve of claim 8 wherein the access receiving ports at the valve body have differing size, shape, design, and method of attachment catering to each particular access port of the instrumentation.

10. The valve of claim 1 wherein the access receiving port is made of metal or non-metal or a combination of both.

11. The valve of claim 1 wherein the access receiving port allow the instrumentation to directly contact a process fluid or product on an inlet side of the passageway of the valve body or on an outlet side of the passageway of the valve body.

12. The valve of claim 1 wherein the access receiving port on the valve body allow removal or replacement of the instrumentation with another instrumentation of a matching access port.

13. The valve of claim 1 wherein the passageway on the valve body of the weir type valve is lengthened to accommodate more access receiving ports.

14. The valve of claim 1 wherein the valve body in the radial style valve is enlarged to accommodate more access receiving ports.

15. A weir type or a radial style valve comprising:
a bonnet, an actuator for controlling the movement of a diaphragm situated between the bonnet and a valve body having an inlet port, an outlet port, a passageway connecting the inlet port and the outlet port for fluid flow, the valve body having a plurality of access receiving ports, the access receiving ports having the same or differing size, shape, design, and method of attachment, each access receiving port catering and connecting to each particular matching access port of an instrumentation, the access receiving port located above or into the passageway of the valve body constructed or positioned to drain into the passageway, each instrumentation selected from the group consisting of test instrument, measuring device and sensing device testing a parameter of a process fluid or product on a process system other than testing or monitoring proper functioning of a device installed along the process system, the instrumentation replaceable and removable from the access receiving port, the access receiving port allowing an instrumentation to directly contact a process fluid or product on an inlet side of the passageway of the valve body or on an outlet side of the passageway of the valve body.

16. The valve of claim 15 wherein the maximum number of access receiving port in the valve body depend upon a structural strength and performance expected from the valve.

17. A method for determining several parameters of a process fluid or product on a process system at a passageway of a valve body of a weir type or a radial style valve to minimize the amount of product loss by minimizing dead legs, comprising:
installing an access receiving port on the valve body;
placing an access port on an instrumentation;
attaching the access port of the instrumentation to a matching access receiving port on the valve body; and,
testing, measuring or sensing the process fluid or product inside the valve body for a parameter other than monitoring proper functioning of a device placed along the process system.

18. The method of claim 17 further comprising removing the instrumentation from a matching access receiving port on the valve body when the instrumentation is not in use.

19. The method of claim 17 further comprising replacing the instrumentation for another instrumentation having the same access port to a matching access receiving port on the valve body.

20. The method of claim 17 wherein the step of installing an access receiving port on the valve body comprises replacing an existing valve body of the valve without an access receiving port with a valve body having an access receiving port.
